(19) United States
(12) Patent Application Publication
(10) Pub. No.: US 2016/0123485 A1
(43) Pub. Date: May 5, 2016

(54) FLUID CONTROL ASSEMBLY

(71) Applicant: Leroy Cardwell, Rockdale, TX (US)

(72) Inventor: Leroy Cardwell, Rockdale, TX (US)

(21) Appl. No.: 14/527,951

(22) Filed: Oct. 30, 2014

(51) Int. Cl. F16K 17/00; B60R 16/03; B60R 15/00

(52) U.S. Cl. CPC F16K 17/00; B60R 15/00; B60R 16/03

(57) ABSTRACT

A fluid control assembly includes a valve coupled to a vehicle. A processor is coupled to the valve. An inlet is coupled to the valve. The inlet is fluidly coupled to a fluid source to direct a fluid into the valve. A vent is coupled to the valve. An outlet is coupled to the valve. The outlet is fluidly coupled to a fluid supply of the vehicle to deliver the fluid to the vehicle. A temperature sensor is coupled to the valve to detect a temperature of the fluid. The temperature sensor is electrically coupled to the processor. The valve allows a flow of the fluid between the inlet and the vent when the temperature sensor detects a fluid temperature that is below a freezing point of the fluid. Thus, the fluid is prevented from freezing in the inlet.

### BACKGROUND OF THE DISCLOSURE

### Field of the Disclosure

The disclosure relates to control devices and more particularly pertains to a new control device for preventing a fluid from freezing in an inlet.

### SUMMARY OF THE DISCLOSURE

An embodiment of the disclosure meets the needs presented above by generally comprising a valve coupled to a vehicle. A processor is coupled to the valve. An inlet is coupled to the valve. The inlet is fluidly coupled to a fluid source to direct a fluid into the valve. A vent is coupled to the valve. An outlet is coupled to the valve. The outlet is fluidly coupled to a fluid supply of the vehicle to deliver the fluid to the vehicle. A temperature sensor is coupled to the valve to detect a temperature of the fluid. The temperature sensor is electrically coupled to the processor. The valve allows a flow of the fluid between the inlet and the vent when the temperature sensor detects a fluid temperature that is below a freezing point of the fluid. Thus, the fluid is prevented from freezing in the inlet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a fluid control assembly according to an embodiment of the disclosure.

FIG. 2 is a top view of an embodiment of the disclosure.

FIG. 3 is a front view of an embodiment of the disclosure.

FIG. 4 is a right side view of an embodiment of the disclosure.

FIG. 5 is a schematic view of an embodiment of the disclosure.

### DESCRIPTION OF THE PREFERRED EMBODIMENT

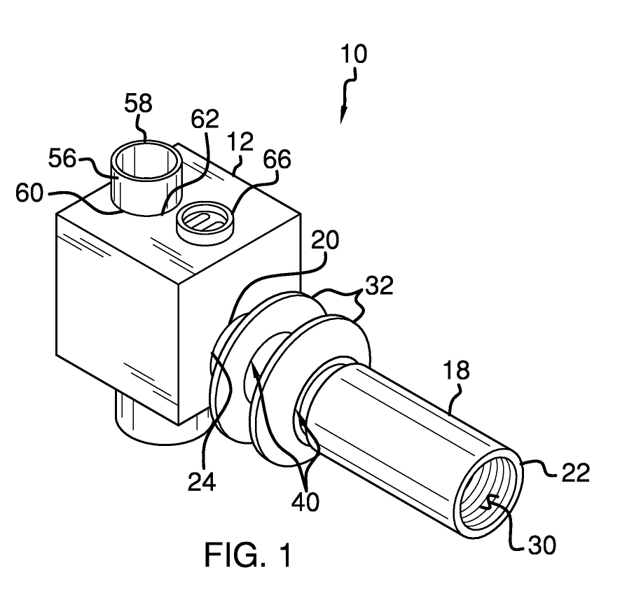

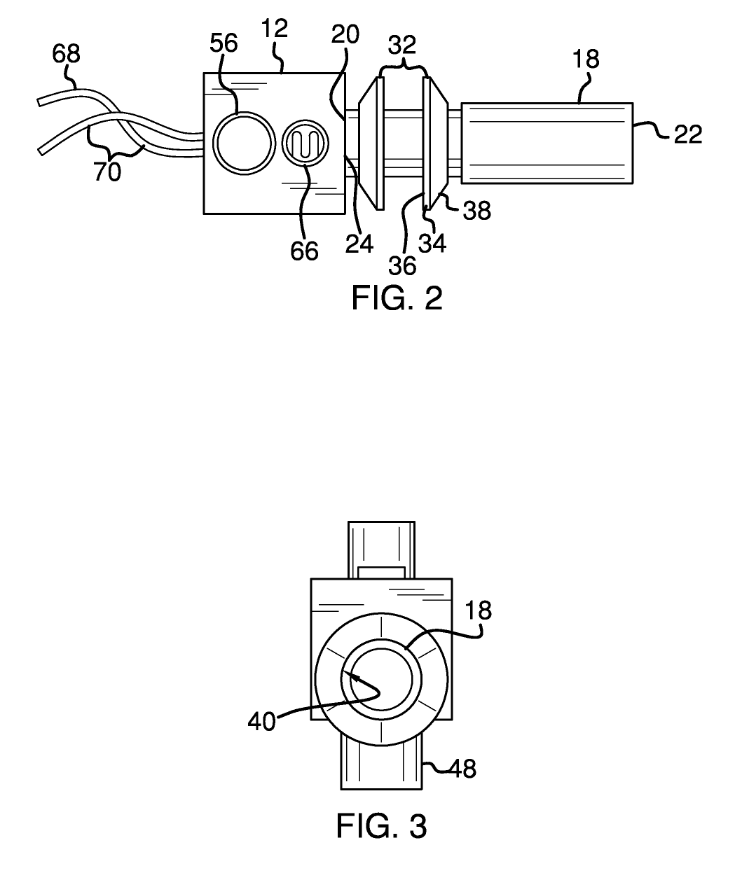

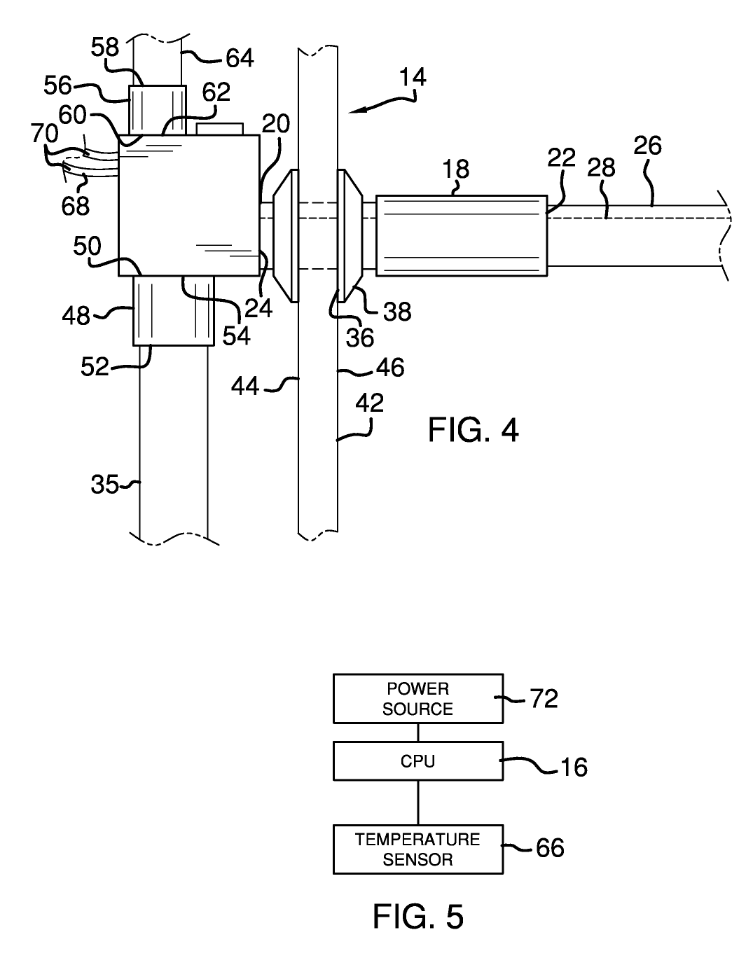

With reference now to the drawings, and in particular to FIGS. 1 through 5 thereof, a new control device embodying the principles and concepts of an embodiment of the disclosure and generally designated by the reference numeral 10 will be described.

As best illustrated in FIGS. 1 through 5, the fluid control assembly 10 generally comprises a valve 12 coupled to a vehicle 14. The vehicle 14 may be a recreational vehicle or the like. A processor 16 is coupled to the valve 12. The processor 16 may be an electronic processor or the like. The valve 12 may be an electrically actuated fluid valve or the like.

An inlet 18 is provided. The inlet 18 has a first end 20 and a second end 22. Each of the first end 20 and the second end 22 of the inlet 18 is open. The inlet 18 is substantially hollow.

The first end 20 of the inlet 18 is fluidly coupled to an intake 24 of the valve 12. The second end 22 is fluidly coupled to a fluid source 26 to direct a fluid 28 into the valve 12. The fluid 28 may be water. The fluid source 26 may be a municipal water supply or the like. An inside surface 30 of the inlet 18 is threaded proximate the second end 22. The fluid source 26 threadably engages the inlet 18.

Each of a pair of flanges 32 has an outer edge 34 extending between a respective front side 36 and a respective back side 38 of the flanges 32. Each of the flanges 32 has a respective opening 40 extending through the front side 36 and the back side 38. The inlet 18 extends through the opening 40 in each of the flanges 32. The flanges 32 are spaced apart on the inlet 18 so the front side 36 of the flanges 32 faces each other. The inlet 18 extends through a wall 42 of the vehicle 14 such that the front side 36 of each of the flanges 32 abuts an associated one of an inside surface 44 and an outside surface 46 of the wall 42. Thus, the flanges 32 retain the valve 12 on the wall 42.

A vent 48 is provided. The vent 48 has a top end 50 and a bottom end 52. Each of the top end 50 and the bottom end 52 is open. The vent 48 is substantially hollow. The top end 50 of the vent 48 is fluidly coupled to an overflow 54 of the valve 12. The bottom end 52 of the vent 48 is fluidly coupled to a drain 55.

An outlet 56 is provided. The outlet 56 has a primary end 58 and a secondary end 60. Each of the primary end 58 and the secondary end 60 is open. The outlet 56 is substantially hollow. The primary end 58 is fluidly coupled to an exhaust 62 of the valve 12. The secondary end 60 is fluidly coupled to a fluid supply line 64 of the vehicle 14 to deliver the fluid 28 to the fluid supply line 64 of the vehicle 14.

A temperature sensor 66 is coupled to the valve 12 to detect a temperature of the fluid 28. The temperature sensor 66 is electrically coupled to the processor 16. The valve 12 restricts a flow of the fluid 28 between the inlet 18 and the vent 48 when the temperature sensor 66 detects a fluid temperature that is above a freezing point of the fluid 28. The freezing point of the fluid 28 may be 0° Celsius.

The valve 12 allows the flow of the fluid 28 between the inlet 18 and the vent 48 when the temperature sensor 66 detects a fluid temperature that is below the freezing point of the fluid 28. Thus, the fluid 28 is prevented from freezing in the inlet 18. The temperature sensor 66 prevents the inlet 18 from bursting to due the formation of ice within the inlet 18. Additionally, the temperature sensor 66 ensures the flow of fluid 28 is constantly available to the fluid supply line 64.

A power supply 68 is coupled to the valve 12. The power supply 68 is electrically coupled to the processor 16. The power supply 68 comprises a pair of conductors 70 extending outwardly from the valve 12. Each of the conductors 70 is electrically coupled to a power source 72. The power source 72 may be the electrical system of the vehicle or the like.

In use, the assembly 10 allows the vehicle 14 to be operated in an environment that produces temperatures below the freezing point of water. The fluid supply line 64 in the vehicle 14 is utilized at any time. The assembly 10 makes additional preventative measures against a frozen fluid source 26 unnecessary.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fluid control assembly comprising:
a valve configured to be coupled to a vehicle;
a processor coupled to said valve;
an inlet coupled to said valve, said inlet being fluidly coupled to a fluid source wherein said inlet is configured to direct a fluid into said valve;
a vent coupled to said valve;
an outlet coupled to said valve, said outlet being fluidly coupled to a fluid supply of the vehicle wherein said outlet is configured to deliver the fluid to the vehicle; and
a temperature sensor coupled to said valve wherein said temperature sensor is configured to detect a temperature of the fluid, said temperature sensor being electrically coupled to said processor, said valve allowing a flow of the fluid between said inlet and said vent when said temperature sensor detects a fluid temperature that is below a freezing point of the fluid wherein the fluid is prevented from freezing in said inlet.

2. The assembly according to claim 1, wherein said inlet having a first end and a second end, each of said first end and said second end of said inlet being open, said inlet being substantially hollow, said first end of said inlet being fluidly coupled to an intake of said valve, said second end being fluidly coupled to the fluid source.

3. The assembly according to claim 2, further comprising a pair of flanges, each of said flanges having an outer edge extending between a respective front side and a respective back side of said flanges, each of said flanges having a respective opening extending through said front side and said back side, said inlet extending through said opening in each of said flanges wherein said flanges are spaced apart on said inlet having said front side of said flanges facing each other.

4. The assembly according to claim 3, wherein said inlet extending through a wall of the vehicle such that said front side of each of said flanges abuts an associated one of an inside surface and an outside surface of the wall wherein said valve is retained on the wall.

5. The assembly according to claim 1, wherein said vent having a top end and a bottom end, each of said top end and said bottom end being open, said vent being substantially hollow, said top end of said vent being fluidly coupled to an overflow of said valve.

6. The assembly according to claim 1, wherein said outlet having a primary end and a secondary end, each of said primary end and said secondary end being open, said outlet being substantially hollow, said primary end being fluidly coupled to an exhaust of said valve, said secondary end being fluidly coupled to the fluid supply line of the vehicle.

7. The assembly according to claim 1, further comprising a power supply coupled to said valve, said power supply being electrically coupled to said processor, said power supply comprising a pair of conductors extending outwardly from said valve, each of said conductors being electrically coupled to a power source.

8. A fluid control assembly comprising:
a valve configured to be coupled to a vehicle;
a processor coupled to said valve;
an inlet, said inlet having a first end and a second end, each of said first end and said second end of said inlet being open, said inlet being substantially hollow, said first end of said inlet being fluidly coupled to an intake of said valve, said second end being fluidly coupled to a fluid source wherein said inlet is configured to direct a fluid into said valve;
a pair of flanges, each of said flanges having an outer edge extending between a respective front side and a respective back side of said flanges, each of said flanges having a respective opening extending through said front side and said back side, said inlet extending through said opening in each of said flanges wherein said flanges are spaced apart on said inlet having said front side of said flanges facing each other;
said inlet extending through a wall of the vehicle such that said front side of each of said flanges abuts an associated one of an inside surface and an outside surface of the wall wherein said valve is retained on the wall;
a vent, said vent having a top end and a bottom end, each of said top end and said bottom end being open, said vent being substantially hollow, said top end of said vent being fluidly coupled to an overflow of said valve;
an outlet, said outlet having a primary end and a secondary end, each of said primary end and said secondary end being open, said outlet being substantially hollow, said primary end being fluidly coupled to an exhaust of said valve, said secondary end being fluidly coupled to a fluid supply line of the vehicle wherein said outlet is configured to deliver the fluid to the fluid supply line of the vehicle;
a temperature sensor coupled to said valve wherein said temperature sensor is configured to detect a temperature of the fluid, said temperature sensor being electrically coupled to said processor, said valve allowing a flow of the fluid between said inlet and said vent when said temperature sensor detects a fluid temperature that is below a freezing point of the fluid wherein the fluid is prevented from freezing in said inlet; and
a power supply coupled to said valve, said power supply being electrically coupled to said processor, said power supply comprising a pair of conductors extending outwardly from said valve, each of said conductors being electrically coupled to a power source.
